(19) United States
(12) Patent Application Publication
(10) Pub. No.: US 2011/0062372 A1
(43) Pub. Date: Mar. 17, 2011

(54) RARE EARTH MAGNETIC MATERIALS AND METHODS THEREOF

(76) Inventors: Qing Gong, Shenzhen (CN); Xiaoxia Deng, Shenzhen (CN); Xin Du, Shenzhen (CN)

(21) Appl. No.: 12/860,575

(22) Filed: Aug. 20, 2010

(30) Foreign Application Priority Data
Sep. 15, 2009 (CN) 200910190316.0

(51) Int. Cl. H01F 1/057

(52) U.S. Cl. 252/62.54; 252/62.55

(57) ABSTRACT

A magnetic material is provided, which is represented by the general formula of: R_{a-x-y}HoₓDy_{y} Fe_{1-a-b-c-d} Co_{d} M_{c}B_{b}, where x, y, a, b, c, and d are weight percentages of related elements and in respective ranges of: about 28%≦a≦about 34%, about 0.95%≦b≦about 1.3%, about 0≦c≦about 1.5%, about 1%≦d≦about 10%, about 15%≦x≦about 20%, about 3%≦y≦about 8%. R is a rare earth element, which is selected from the group consisting of: Nd, Pr, La, Ce, Gd, Tb, and combinations thereof. M is a metal selected from the group consisting of: Al, Cu, Ti, V, Cr, Zr, Hf, Mn, Nb, Sn, Mo, Ga, Si, and combinations thereof.

### CROSS-REFERENCE TO RELATED APPLICATION

This application claims the priority and benefit of Chinese Patent Application No. CN 200910190316.0, filed with State Intellectual Property Office, P. R. C., on Sep. 15, 2009.

### FIELD OF THE DISCLOSURE

The present disclosure relates generally to magnetic materials and preparation methods thereof. In more particularity, the present disclosure relates to rare earth permanent magnetic materials, having Holmium and Dysprosium, and preparation methods thereof.

### BACKGROUND

Magnetic materials formed of rare earth elements are generally known. Without limitation, an exemplary rare earth permanent magnetic material may be represented by the formula of Re_{α}Ho_{β}B_{γ}MₓN_{y}Fe_{1-α-β-γ-x-y}, in which Re is a rare earth element including Nd, or the combination of Nd and one or more elements selected from a group consisting of La, Ce, Pr, Pm, Sm, Eu, Tb, Dy, Ho, Er, Tm, Yb, Lu, Y, and Sc; M is an additive including Co and Cu; N is an additive selected from a group consisting of Al, Ga, Nb, Zr, Ti, Sn, and combinations thereof; and α, β, γ, x, and y are weight percentages of the corresponding elements having the following values: 29%≦α≦35%, 0.05%≦β≦0.5%, 0.95%≦γ≦1.2%, 0≦x≦10%, 0≦y≦1.5%.

### SUMMARY OF THE DISCLOSURE

In accordance with various illustrative embodiments hereinafter disclosed are magnetic materials, which may be represented by the general formula of: R_{a-x-y}HoₓDy_{y}Fe_{1-a-b-c-d} Co_{d} M_{c}B_{b}, where x, y, a, b, c, and d are weight percentages of corresponding elements and in respective ranges of: about 28%≦a≦about 34%, about 0.95%≦b≦5 about 1.3%, about 0≦c≦about 1.5%, about 1%≦d≦about 10%, about 15%≦x≦about 20%, about 3%≦y≦about 8%. R may be a first element selected from the group consisting of Nd, Pr, La, Ce, Gd, Tb, and combinations thereof. M may be a second element selected from the group consisting of Al, Cu, Ti, V, Cr, Zr, Hf, Mn, Nb, Sn, Mo, Ga, Si, and combinations thereof.

In accordance with another illustrative embodiment hereinafter disclosed are methods of preparing magnetic materials. The methods may include preparing at least three elements for manufacturing a magnetic material and casting the at least three elements into an ingot or strip casting flake. The first element may be selected from the group consisting of Nd, Pr, La, Ce, Gd, Tb, and combinations thereof; the second element may include Ho; and the third element may include Dy. The method further may include crushing and jet milling the ingot or casting flake to form a powder followed by mixing with an antioxidant to form a mixing powder. The mixing powder may be pressed in a magnetic field to form a parison. The parison may be calcinated, and the calcinated parison may be tempered.

While the rare earth permanent magnetic materials and methods thereof will be described in connection with various preferred illustrative embodiments, it will be understood that it is not intended to limit the rare earth magnetic materials and methods thereof to those embodiments. On the contrary, it is intended to cover all alternatives, modifications, and equivalents as may be included within the spirit and scope of the invention as defined by the appended claims.

### DETAILED DESCRIPTION OF THE EMBODIMENT

In an illustrative, non-limiting, embodiment of the present disclosure, a magnetic material is provided, which may be represented by the general formula of: R_{a-x-y}HoₓDy_{y}Fe_{1-a-b-c-d} Co_{d}M_{c}B_{b}, where x, y, a, b, c, and d are weight percentages of related elements and in respective ranges of: about 28%≦a≦about 34%, about 0.95%≦b≦about 1.3%, about 0≦c≦about 1.5%, about 1%≦d≦about 10%, about 15%≦x≦about 20%, about 3%≦y≦about 8%; R is rare earth element, which may be selected from a group consisting of Nd, Pr, La, Ce, Gd, Tb, and combinations thereof; and M may be selected from the group consisting of: Al, Cu, Ti, V, Cr, Zr, Hf, Mn, Nb, Sn, Mo, Ga, Si, and combinations thereof.

In an alternative embodiment, a magnetic material is provided, which may be represented by the general formula of: R_{a-x-y}HoₓDy_{y}Fe_{a-b-c-d} CO_{d} M_{c}B_{b}, where x, y, a, b, c, and d may have respective ranges of: about 30%≦a≦about 33%, about 0.97%≦b≦about 1.2%, about 0.1%≦c≦about 1.3%, about 1.5%≦d≦about 9%, about 17%≦x≦about 19%, about 4.1%≦y≦about 7.7%; R may be selected from Nd, Tb, and combinations thereof; and M may be selected from the group consisting of: AI, Cu, Ti, V, Cr, Zr, Hf, Mn, Nb, Sn, Mo, Ga, Si, and combinations thereof.

In a still further embodiment, a magnetic material is provided, which may be represented by the general formula of: R_{a-x-y}HoₓDy_{y}Fe_{1-a-b-c-d} Co_{d} M_{c}B_{b}, where x, y, a, b, c, and d may have respective ranges of: about 28%≦a≦about 34%, about 0.95%≦b≦about 1.3%, about 0≦c≦about 1.5%, about 1%≦d≦about 10%, about 15%≦x≦about 20%, about 3%≦y≦about 8%, and alternatively, about 30%≦a≦about 33%, about 0.97%≦b≦about 1.2%, about 0.1%≦c≦about 1.3%, about 1.5%≦d≦about 9%, about 17%≦x≦about 19%, about 4.1%≦y≦about 7.7%; R may be comprised of Nd and Tb, having a weight ratio of from about 5.6:to about 10.1:1; and M may be selected from the group consisting of: Al, Cu, Ti, V, Cr, Zr, Hf, Mn, Nb, Sn, Mo, Ga, Si, and combinations thereof.

Without wishing to be bound by the theory, Applicant believes that the presence of Ho and Dy may increase the coercivity and maximum operation temperature of the material. In an embodiment, the term “maximum operation temperature” is the highest temperature that a permanent material can be kept for 2 hours with an irreversible magnetic flux lost less than about 5%. In an embodiment, the magnetic materials described herein may be called “rare earth permanent magnetic materials.” In an embodiment, without limitation, a “permanent magnetic material” is an object made from a material that is magnetized and creates its own persistent magnetic field.

In a non-limiting, illustrative, embodiment, a method for preparing a magnetic material may comprise the steps of: preparing at least three elements for manufacturing the magnetic material and casting the at least three elements into an ingot or strip casting flake; crushing and/or jet milling the ingot or strip casting flake to form a powder followed by mixing with an antioxidant to form a mixing powder; pressing the mixing powder in a magnetic field to form a parison; calcining the parison; and tempering the calcinated parison. In an embodiment, the first of the at least three elements may be selected from the group consisting of Nd, Pr, La, Ce, Gd, Tb, and combinations thereof, the second of the at least three elements may include Ho, and the third of the at least three elements may include Dy.

The casting process may be any of those known in the art. In an embodiment, casting the material into an ingot may include casting a melted alloy in a water-cooled copper mold. In an embodiment, the strip casting flaking process may be any of those known in the art, and may comprise steps of: pouring a melted alloy onto a rotating copper roller surface, with a rotating linear velocity of the copper roller surface ranging from about 1 meter per second (m/s) to about 2 m/s; and then rapidly cooling the melted alloy to form flakes having a plurality of widths and having an overall average thickness ranging from about 0.2 millimeters to about 0.5 millimeters.

In an embodiment, the crushing step may be any of known in the art, and may in particular be performed in a hydrogen decrepitation process, or mechanical crushing process. In an embodiment, the hydrogen decrepitation process may utilize a hydrogen decrepitation furnace, as known in the art. The hydrogen decrepitation process may further comprise, for example, the steps of: introducing a rare earth magnetic material into a stainless steel vessel; filling the vessel with high purity hydrogen (at least about 95% pure) until about one atmospheric pressure after vacuumizing; and maintaining at the pressure for about 20 minutes to about 30 minutes until the material decrepitates, and the temperature the vessel increases. Without wishing to be bound by the theory, the decrease in temperature may be resulted from the decrepitation of the material due to the formation of a hydride after the material absorbs hydrogen, and finally vacuumizing and dehydrogenating the hydride for about 2 hours to about 10 hours under the temperature about 400 degrees centigrade (° C.) to about 600° C. In some embodiments, the mechanical crushing process may be any of those known in the art, and may comprise, for example, rough crushing the material in a jaw crusher, followed by mechanical crushing in a fine crusher.

The jet milling process may be any of those known in the art. For example, the jet mill process may comprise the steps of: accelerating powder particles to a supersonic speed using an air flow, and then causing the particles to clash with each other to break up. In an embodiment, the rare earth magnetic material powders may have an overall average diameter ranging from about 2 microns to about 10 microns.

In an embodiment, the antioxidant may be present in an amount ranging from about 0.1% to about 5% of the magnetic material powders by weight. Suitable antioxidants may include any of those known in the art, including without limitation: one or more antioxidants selected from polyethylene oxide alkyl ether, polyethylene oxide monofatty ester, and polyethylene oxide alkenyl ether.

The mixing process may be any of those known in the art. For example, the mixing process may be carried out in a mixer.

The pressing step may be any of known. In an alternative embodiment, the pressing may be achieved by a magnetically orienting-forming-pressing machine. The orienting magnetic field may have an intensity ranging from about 1.2 tesla (T) to about 2.0 T, and the pressing may be carried out under a pressure of about 10 megapascal (MPa) to about 200 MPa for about 10 seconds to about 60 seconds.

Suitable calcining and tempering processes may include any of those known in the art. In an embodiment, the calcining may be carried out under a vacuum. In an embodiment, the parison may be calcined under a vacuum degree ranging from about 2×10⁻² pascals (Pa) to 5×10⁻² Pa, at a temperature of from about 1,030° C. to about 1,120° C. for a period ranging from about 2 hours to about 4 hours. Following calcination, the parison may be tempered in a first tempering step at a temperature ranging from about 800° C. to about 920° C. for a period of time ranging from about 1 hour to about 3 hours, and tempered in a second tempering step at a temperature ranging from about 500° C. to about 650° C. for a period of time ranging from about 2 hours to about 4 hours.

The present disclosure will be further described in detail with reference to the following examples:

### Example 1

A first rare earth magnetic material (hereafter “T1”) was prepared according to the following steps:

(1) Metal elements Pr, Nd, Dy, Tb, Ho, B, Fe, Co, Al, Cu, Zr, and Ga with respective weight percentages of 0.46%, 2.02%, 2.80%, 0.20%, 17.91%, 1%, 73.11%, 1.65%, 0.2%, 0.15%, 0.15%, 0.1% were casted by a strip casting flaking process with a rotating linear velocity of a copper roller surface of about 1.5 meters per second (m/s). The flake had a thickness of about 0.3 millimeter;

(2) The flake was crushed by a hydrogen decrepitation process in a hydrogen decrepitation furnace, and jet milled to produce a powder with an average particle diameter of about 3.5 microns.

(3) Polyethylene oxide alkyl ether, in a quantity of about 3% of the weight of the powder, was added into the powder and mixed uniformly by a mixer to form a mixed powder;

(4) The mixed powder was pressed to form a parison by using a magnetically orienting-forming-pressing machine. The intensity of the orienting magnetic field was about 1.2 T, the pressure was about 200 MPa, and the pressing time was about 10 seconds.

(5) The parison was calcined in a vacuum under a vacuum degree of 2×10⁻² Pa at a temperature of about 1,080° C. for about 3 hours, then tempered at about 850° C. for about 2 hours, and finally tempered at about 550° C. for about 3 hours to prepare T1, a Pr_{0.46}Nd_{2.02}Dy_{2.80}Tb_{0.20}Ho_{17.91}B₁Fe_{73.11}CO_{1.65}Al_{0.2}Cu_{0.15}Zr_{0.15}Ga_{0.1} rare earth magnetic material.

### Comparative Example 1

A comparative rare earth magnetic material (hereafter “CT1”) was prepared according to the following steps:

(1) PrNd metal alloy, metal elements: Ho, Dy, Gd, B, Cu, Al, Co, Nb, and Fe with respective weight percentages of 28%, 4%, 0.5%, 1.0%, 1%, 0.1%, 0.55%, 0.7%, 0.2%, and 63.95% were casted by a strip casting flaking process with a rotating linear velocity of a copper roller surface of about 1.5 meters per second (m/s). The flake had a thickness of about 0.3 millimeter;

(2) The flake was crushed by a hydrogen decrepitation process in a hydrogen decrepitation furnace, and jet milled to produce a powder having an overall average particle diameter of about 3.5 microns;

(3) Polyethylene oxide alkyl ether, in a quantity of about 3% of the weight of the powder, was added into the powder and mixed uniformly by a mixer to form a mixed powder;

(4) The mixed powder was pressed to form a parison by using a magnetically orienting-forming-pressing machine. The intensity of the orienting magnetic field was about 1.2 T, the pressure was about 200 MPa, and the pressing time was about 10 seconds;

(5) The parison was calcined in a vacuum under a vacuum degree of 2×10⁻² Pa at a temperature of about 1,080° C. for about 3 hours, then tempered at about 850° C. for about 2 hours, and finally tempered at about 550° C. for about 3 hours to prepare CT1, a (PrNd)₂₈Ho₄Dy_{0.5}Gd_{1.0}B₁Cu_{0.1}Al_{0.55}Co_{0.7}Nb_{0.2}Fe_{63.95} rare earth permanent magnetic material.

### Example 2

A second rare earth magnetic material (hereafter “T2”) was prepared according to the following steps:

(1) Metal elements Pr, Nd, Dy, Ho, B, Fe, and Co with respective weight percentages of 5.2%, 3.8%, 8%, 17%, 1%, 63.5%, 1.5% were casted by a strip casting flaking process with a rotating linear velocity of a copper roller surface of about 1.2 meters per second (m/s). The flake had an average thickness of about 0.38 millimeters;

(2) The flake was crushed by a hydrogen decrepitation process in a hydrogen decrepitation furnace. After absorbing hydrogen to saturation at room temperature and being dehydrogenated at about 550° C. for about 6 hours, the material was then jet milled to produce a powder having an average particle diameter of about 3.8 microns;

(3) Polyethylene oxide monofatty ester, about 0.2% of the weight of the powder was added into the powder and mixed uniformly by a mixer to form a mixed powder;

(4) The mixed powder was pressed to form a parison by using a magnetically orienting-forming-pressing machine. The intensity of the orienting magnetic field was about 1.5 T, the pressure was about 150 MPa, and the pressing time was about 15 seconds;

(5) The parison was calcined in a vacuum under a vacuum degree of 2×10⁻² Pa at a temperature of about 1,085° C. for about 3 hours, then tempered at about 880° C. for about 2.5 hours, and finally tempered at about 580° C. for about 2.5 hours to prepare T2, a Pr_{5.2}Nd_{3.8}Dy₈Ho₁₇B₁Fe_{63.5}CO_{1.5} rare earth magnetic material.

### Example 3

A third rare earth magnetic material (hereafter “T3”) was prepared according to the following steps:

(1) Metal elements Pr, Nd, Dy, Ho, B, Fe, Co, Al, Cu, Zr, and Ga with respective weight percentages of: 1%, 6%, 6.5%, 18%, 0.95%, 61.95%, 5%, 0.2%, 0.15%, 0.15% and 0.1% were casted by a strip casting flaking process with a rotating linear velocity of a copper roller surface of about 1.4 meters per second (m/s). The flake had an average thickness of about 0.35 millimeters;

(2) The flake was crushed by a hydrogen decrepitation process in a hydrogen decrepitation furnace. After absorbing hydrogen to saturation at room temperature and being dehydrogenated at about 550° C. for about 6 hours, then the material was jet milled to to produce a powder with an average particle diameter of about 3.6 microns;

(3) Polyethylene oxide alkenyl ether, in a quantity of about 5% of the weight of the powder, was added into the powder and mixed uniformly by a mixer to form a mixed powder;

(4) The mixed powder was pressed to form a parison by using a magnetically orienting-forming-pressing machine. The intensity of the orienting magnetic field was about 1.6 T, the pressure was about 140 MPa, and the pressing time was about 20 seconds.

(5) The parison was calcined in a vacuum under a vacuum degree of 2×10⁻² Pa at a temperature of about 1,090° C. for about 3 hours, then tempered at about 900° C. for about 2.5 hours, and finally tempered at about 540° C. for about 3 hours to prepare T3, a Pr₁Nd₆Dy_{6.5}Ho₁₈B_{0.95}Fe_{61.95}CO₅Al_{0.2}Cu_{0.15}Zr_{0.15}Ga_{0.1} rare earth magnetic material.

### Example 4

A fourth rare earth magnetic material (hereafter “T4”) was prepared according to the following steps:

(1) Metal elements Nd, Dy, Ho, B, Fe, Co, Al, Cu, Zr, and Ga with respective weight percentages of: 3.5%, 6%, 18.5%, 1%, 69.25%, 1%, 0.3%, 0.15%, 0.15%, and 0.15% were casted by a strip casting flaking process with a rotating linear velocity of a copper roller surface of about 2.2 meters per second (m/s). The flake had an overall average thickness of about 0.28 millimeters;

(2) The flake was crushed by a hydrogen decrepitation process in a hydrogen decrepitation furnace. After absorbing hydrogen to saturation at room temperature and being dehydrogenated at about 550° C. for about 6 hours, then the material was jet milled to produce a powder with an average particle diameter of about 2 microns;

(3) Polyethylene oxide alkenyl ether, in a quantity of about 4.5% of the weight of the powder, was added into the powder and mixed uniformly by a mixer to form a mixed powder;

(4) The mixed powder was pressed to form a parison by using a magnetically orienting-forming-pressing machine. The intensity of the orienting magnetic field was about 2.0 T, the pressure was about 10 MPa, and the pressing time was about 50 seconds;

(5) The parison was calcined in a vacuum under a vacuum degree of 2×10⁻² Pa at a temperature of about 1,030° C. for about 4 hours, then tempered at about 900° C. for about 2 hours, and finally tempered at about 520° C. for about 3 hours to prepare T4, a Nd_{3.5}Dy₆Ho_{18.5}B₁Fe_{69.25}CO₁Al_{0.3}Cu_{0.15}Zr_{0.15}Ga_{0.15} rare earth magnetic material.

### Example 5

A fifth rare earth magnetic material (hereafter “T5”) was prepared according to the following steps:

(1) Metal elements Pr, Nd, Dy, Ho, B, Fe, Co, Al, Cu, Zr, and Ga with respective weight percentages of 1%, 6.9%, 7.6%, 16%, 0.98%, 56.92%, 10%, 0.2%, 0.15%, 0.15%, and 0.1% were casted by a strip casting flaking process with a rotating linear velocity of a copper roller surface of about 1 meter per second (m/s). The flake had an overall average thickness of about 0.42 millimeters;

(2) The flake was crushed by a hydrogen decrepitation process in a hydrogen decrepitation furnace. After absorbing hydrogen to saturation at room temperature and being dehydrogenated at about 560° C. for about 6 hours, the material was then jet milled to produce a powder with an average particle diameter of about 4.2 microns;

(3) Polyethylene oxide alkenyl ether, in a quantity of about 3% of the weight of the powder, was added into the powder and mixed uniformly by a mixer to form a mixed powder;

(4) The mixed powder was pressed to form a parison by using a magnetically orienting-forming-pressing machine. The intensity of the orienting magnetic field was about 1.2 T, the pressure was about 200 MPa, and the pressing time was about 10 seconds.

(5) The parison was calcined in a vacuum under a vacuum degree of 2×10⁻² Pa at a temperature of about 1,065° C. for about 3.5 hours, then tempered at about 870° C. for about 2.5 hours, and finally tempered at about 540° C. for about 2.5 hours to prepare T5, a Pr₁Nd_{6.9}Dy_{7.6}Ho₁₆B_{0.98}Fe_{56.92}CO₁₀Al_{0.2}Cu_{0.15}Zr_{0.15}Ga_{0.1} are earth magnetic material.

### Example 6

A sixth rare earth magnetic material (hereafter “T6”) was prepared according to the following steps:

(1) Metal elements Pr, Nd, Dy, Tb, Ho, B, Fe, Co, Al, Cu, and Zr with respective weight percentages of 1%, 5%, 4.1%, 0.5%, 19%, 1%, 67.35%, 1.5%, 0.25%, 0.15%, and 0.15% were casted by a strip casting flaking process with a rotating linear velocity of a copper roller surface of about 0.8 meter per second (m/s). The flake had an overall average thickness of about 0.45 millimeters;

(2) The flake was crushed by a hydrogen decrepitation process in a hydrogen decrepitation furnace. After absorbing hydrogen to saturation at room temperature and being dehydrogenated at about 550° C. for about 6 hours, then the material was jet milled to produce a powder with an average particle diameter of about 4.5 microns;

(3) Polyethylene oxide alkenyl ether, in a quantity of about 4% of the weight of the powder, was added into the powder and mixed uniformly by a mixer to form a mixed powder;

(4) The mixed powder was pressed to form a parison by using a magnetically orienting-forming-pressing machine. The intensity of the orienting magnetic field was about 1.4 T, the pressure was about 100 MPa, and the pressing time was about 60 seconds.

(5) The parison was calcined in a vacuum under a vacuum degree of 2×10⁻² Pa at a temperature of about 1,085° C. for about 4 hours, then tempered at about 920° C. for about 1 hours, and finally tempered at about 650° C. for about 2 hours to prepare T6, a Pr₁Nd₅Dy_{4.1}Tb_{0.5}Ho₁₉B₁Fe_{67.35}CO_{1.5}Al_{0.25}Cu_{0.15}Zr_{0.15} rare earth magnetic material.

### Example 7

A seventh rare earth magnetic material (hereafter “T7”) was prepared according to the following steps:

(1) Metal elements Pr, Nd, Dy, Tb, Ho, B, Fe, Co, Al, and Nb with respective weight percentages of 1.4%, 5.6%, 3%, 1%, 20%, 1%, 65%, 1.5%, 0.3%, 1.2% were casted by a strip casting flaking process with a rotating linear velocity of a copper roller surface of about 0.6 meter per second (m/s). The flake had an overall average thickness of about 0.5 millimeters;

(2) The flake was crushed by a hydrogen decrepitation process in a hydrogen decrepitation furnace. After absorbing hydrogen to saturation at room temperature and being dehydrogenated at about 550° C. for about 6 hours, then the material was jet milled to to produce a powder with an average particle diameter of about 4.8 microns;

(3) Polyethylene oxide alkenyl ether, in a quantity of about 3% of the weight of the powder, was added into the powder and mixed uniformly by a mixer to form a mixed powder;

(4) The mixed powder was pressed to form a parison by using a magnetically orienting-forming-pressing machine. The intensity of the orienting magnetic field was about 1.6 T, the pressure was about 180 MPa, and the pressing time was about 30 seconds.

(5) The parison was calcined in a vacuum under a vacuum degree of 2×10⁻² Pa at a temperature of about 1,095° C. for about 3 hours, then tempered at about 820° C. for about 2.5 hours, and finally tempered at about 510° C. for about 3.5 hours to prepare T7, a Pr_{1.4}Nd_{5.6}Dy₃TbHo₂₀B₁Fe₆₅CO_{1.5}Al_{0.3}Nb_{1.2} rare earth magnetic material.

### Example 8

An eighth rare earth magnetic material (hereafter “T8”) was prepared according to the following steps:

(1) Metal elements Nd, Dy, Ho, B, Fe, Co, Al, Cu, Zr and Ga with respective weight percentages of 5%, 5.2%, 19.3%, 1.3%, 67.6%, 1%, 10.2%, 0.15%, 0.15%, and 0.1% were casted in a water-cooled copper mould to form an ingot;

(2) The ingot was crushed by rough crushing in a jaw crusher, to produce a powder with an average particle diameter of about 10 microns;

(3) Polyethylene oxide alkyl ether, in a quantity of about 5% of the weight of the powder, was added into the powder and mixed uniformly by a mixer to form a mixed powder;

(4) The mixed powder was pressed to form a parison by using a magnetically orienting-forming-pressing machine. The intensity of the orienting magnetic field was about 1.2 T, the pressure was about 200 MPa, and the pressing time was about 10 seconds.

(5) The parison was calcined in a vacuum under a vacuum degree of 5×10⁻² Pa at a temperature of about 1,120° C. for about 2 hours, then tempered at about 800° C. for about 3 hours, and finally tempered at about 500° C. for about 4 hours to prepare T8, a Nd₅Dy_{5.2}Ho_{19.3}B₁Fe_{67.6}CO₁Al_{0.2}Cu_{0.15}Zr_{0.15}Ga_{0.1} rare earth magnetic material.

### Comparative Example 2

A second comparative rare earth magnetic material (hereafter “CT2”) was prepared according to the following steps:

(1) About 100 kg metal elements Pr, Nd, Gd, Ho, Dy, B, Cu, Al, Co, Nb, and Fe with respective weight percentages of 1%, 26%, 0.5%, 1%, 6.0%, 1%, 0.15%, 0.7%, 1.5%, 0.8%, and 62.35% were melted to form an ingot in a furnace with a vacuum degree of about 5×10⁻²Pa,

(2) The ingot was rough crushed and fined crushed to form a powder;

(3) Dy₂O₃, in a quantity of about 1% of the weight of the powder, was added into the powder and jet milled form a mixed powder with an average particle diameter of about 3.5 microns to about 4.2 microns;

(4) The mixed powder was pressed to form a parison under a pressure of about 200 MPa;

(5) The parison was calcined under a vacuum degree of about 3×10⁻² Pa at a temperature of about 1,100° C. for about 1 hour, then tempered at about 920° C. for about 3 hours, and finally tempered at about 530° C. for about 4 hours, and then manufactured to form CT2, a rare earth magnetic material.

Testing

Coercivities and irreversible magnetic flux lost at different operation temperatures of the rare earth magnetic materials T1-T8, CT1 and CT2 were tested using a curve measurement system NIM200C (National Institute of Metrology, P.R.C.).

The results are reproduced below in Table 1.

TABLE 1

| | T1 | T2 | T3 | T4 | T5 | T6 | T7 | T8 | CT1 | CT2 |
|---|---|---|---|---|---|---|---|---|---|---|
| Coercivity (kOe) | 28.54 | 27.98 | 27.0 | 26.94 | 28.52 | 26.52 | 26.48 | 26.86 | 20.79 | 26.83 |
| irr 200° C. (%) | 1.2 | 1.3 | 1.37 | 1.5 | 1.24 | 1.6 | 1.78 | 1.62 | 6.7 | 5.2 |
| irr 240° C. (%) | 3.6 | 4 | 4.2 | 4.3 | 3.8 | 4.5 | 3.5 | 4.5 | 10 | 9.6 |

In Table 1, “irr 200° C.” means the irreversible magnetic flux lost at an operation temperature of 200° C., and “irr 240° C.” means the irreversible magnetic flux lost at an operation temperature of 240° C. Without wishing to be bound by the theory, Applicant believes that Table 1 illustrates that rare earth magnetic materials according to embodiments of the present disclosure may have an irreversible magnetic flux lost of less than 5% at an operation temperature of 200° C., and can operate normally at an operation temperature of 240° C.

Although explanatory embodiments have been shown and described, it would be appreciated by those skilled in the art that changes, alternatives, and modifications all falling into the scope of the claims and their equivalents can be made in the embodiments without departing from spirit and principles of the disclosure.

What is claimed is:

1. A composition comprising: a magnetic material represented by the general formula of:
R_{a-x-y}HoₓDy_{y}Fe_{1-a-b-c-d}CO_{d}M_{c}B_{b}
where x, y, a, b, c, and d are weight percentages of corresponding elements and in respective ranges of: about 28%≦a≦about 34%, about 0.95%≦b≦about 1.3%, about 0≦c≦about 1.5%, about 1%≦d≦about 10%, about 15%≦x≦about 20%, about 3%≦y≦about 8%;
R is a first element, which is selected from the group consisting of Nd, Pr, La, Ce, Gd, Tb, and combinations thereof;
M is a second element selected from the group consisting of Al, Cu, Ti, V, Cr, Zr, Hf, Mn, Nb, Sn, Mo, Ga, Si, and combinations thereof.

2. The composition of claim 1, wherein x, y, a, b, c, and d are in respective ranges of about 30%≦a≦about 33%, about 0.97%≦b≦about 1.2%, about 0.1%≦c≦about 1.3%, about 1.5%≦d≦about 9%, about 17%≦x≦about 19%, about 4.1%≦y≦about 7.7%.

3. The composition of claim 1, wherein R is selected from Nd, Tb, and combinations thereof.

4. The composition of claim 3, wherein R comprises Nd and Tb having a weight ratio ranging from about 5.6:1 to about 10.1:1.

5. The composition of claim 1, represented by the following formula:
Pr_{0.46}Nd_{2.02}Dy_{2.80}Tb_{0.20}Ho_{17.91}B₁Fe_{73.11}CO_{1.65}Al_{0.2}CU_{0.15}Zr_{0.15}Ga_{0.1}.

6. A method for preparing a composition, comprising:
preparing at least three elements for manufacturing a magnetic material and casting the at least three elements into an ingot or strip casting flake, wherein the first element is selected from the group consisting of Nd, Pr, La, Ce, Gd, Tb, and combinations thereof, the second element is Ho, and the third element is Dy;
crushing and jet milling the ingot or casting flake to form a powder followed by mixing with an antioxidant to form a mixing powder;
pressing the mixing powder in a magnetic field to form a parison;
calcining the parison; and
tempering the calcinated parison.

7. The method of claim 6, wherein the magnetic material is represented by the general formula of:
R_{a-x-y}HoₓDy_{y}Fe_{1-a-b-c-d}CO_{d}M_{c}B_{b}
where x, y, a, b, c, and d are weight percentages of corresponding elements and in respective ranges of: about 28%≦a≦about 34%, about 0.95%≦b≦about 1.3%, about 0≦c≦about 1.5%, about 1%≦d≦about 10%, about 15%≦x≦about 20%, about 3%≦y≦about 8%;
R is a first element, which is selected from the group consisting of Nd, Pr, La, Ce, Gd, Tb, and combinations thereof;
M is a second element selected from a group consisting of Al, Cu, Ti, V, Cr, Zr, Hf, Mn, Nb, Sn, Mo, Ga, Si, and combinations thereof.

8. The method of claim 7, wherein x, y, a, b, c, and d are in respective ranges of about 30%≦a≦about 33%, about 0.97%≦b≦about 1.2%, about 0.1%≦c≦about 1.3%, about 1.5%≦d≦about 9%, about 17%≦x≦about 19%, about 4.1%≦y≦about 7.7%.

9. The composition of claim 7, wherein R is selected from Nd, Tb, and combinations thereof.

10. The composition of claim 9, wherein R comprises Nd and Tb having a weight ratio ranging from about 5.6:1 to about 10.1:1.

11. The composition of claim 7, represented by the following formula:
Pr_{0.46}Nd_{2.02}Dy_{2.80}Tb_{0.20}Ho_{17.91}B₁Fe_{73.11}CO_{1.65}Al_{0.2}CU_{0.15}Zr_{0.15}Ga_{0.1}.

12. The method of claim 6, wherein the composition has an average diameter ranging from about 2 microns to about 10 microns.

13. The method of claim 6, wherein the tempering step is performed under a temperature of from about 500° C. to about 920° C.

14. The method of claim 6, wherein the antioxidant is selected from the group consisting of polyethylene oxide alkyl ether, polyethylene oxide monofatty ester, polyethylene oxide alkenyl ether, and combinations thereof.

15. The method of claim 6, wherein the antioxidant is from about 0.1% to about 5% of the powder by weight.

16. The method of claim 6, wherein the pressing step is performed under a magnetic field intensity ranging from about 1.2 T to about 2.0 T.

17. The method of claim 16, wherein the pressing step is performed under a pressure of about 10 MPa to about 200 MPa for a pressing time of from about 10 seconds to about 60 seconds.

18. The method of claim 6, wherein the calcining step is performed under a vacuum degree of about 2×10⁻² Pa to 5×10⁻² Pa, a calcining temperature ranging from about 1,030° C. to about 1,120° C., and for a time ranging from about 2 hours to about 4 hours.

19. The method of claim 6, wherein the tempering step has a tempering time ranging from about 2 hours to about 8 hours.

20. The method of claim 6, wherein the tempering step is performed under a vacuum degree of from about 2×10⁻² Pa to 5×10⁻² Pa.
